(19) United States
(12) Patent Application Publication
(10) Pub. No.: US 2016/0259466 A1
(43) Pub. Date: Sep. 8, 2016

(54) ARRAY SUBSTRATE AND DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Honggang GU, Beijing (CN); Xiaohe LI, Beijing (CN); Xianjie SHAO, Beijing (CN)

(21) Appl. No.: 14/741,877

(22) Filed: Jun. 17, 2015

(30) Foreign Application Priority Data
Mar. 6, 2015 (CN) 201510100099.7

(51) Int. Cl. G06F 3/041; G09G 3/36; G06F 3/044

(52) U.S. Cl. CPC G06F 3/0416; G06F 3/044; G06F 3/0412; G09G 3/3648; G06F 2203/04103; G06F 2203/04112; G09G 2300/0426; G09G 2300/0439; G09G 2300/0478

(57) ABSTRACT

An array substrate and a display device are disclosed. The array substrate includes a base substrate, a transmitting touch electrode pattern and a receiving touch electrode pattern; the transmitting touch electrode pattern is formed on a first face of the base substrate, the receiving touch electrode pattern is formed on a second face of the base substrate, and the first face and the second face are opposite to each other. With the array substrate, shadows of the transmitting touch electrode pattern and the receiving touch electrode pattern can be eliminated or alleviated, and the transmitting touch electrode pattern and the receiving touch electrode pattern can be avoided from being scratched.

### TECHNICAL FIELD

Embodiments of the present disclosure relate to an array substrate and a display device.

### BACKGROUND

Due to ease of use, multi-functionality of touch screens as well as constantly declined price, steadily improved manufacturing yield and other factors, touch screens become more and more popular. Touch screens can be classified into an add-on mode and an in-cell mode according to the location of the electrode structure(s) for realizing touch function. The add-on mode is that, a panel with a touch function is positioned in front of a display device, and touch control is achieved by allowing the touch area to cover a display area of the display device. The in-cell mode is that, the touch function is integrated in a panel, a protective glass is attached outside. A user can realize a touch operation by touching the screen with a finger for example.

### SUMMARY

According to at least an embodiment of the present disclosure, there is provided an array substrate, which includes a base substrate, a transmitting touch electrode pattern and a receiving touch electrode pattern; the transmitting touch electrode pattern is formed on a first face of the base substrate, the receiving touch electrode pattern is formed on a second face of the base substrate, and the first face and the second face are opposite to each other.

For example, in an embodiment, the array substrate further includes a display driving signal line, wherein the transmitting touch electrode pattern or the receiving touch electrode pattern is located on the same face as the display driving signal line of the array substrate, and is formed below the display driving signal line.

For example, in an embodiment, wirings of the transmitting touch electrode pattern and wirings of the receiving touch electrode pattern are perpendicular to each other.

According to at least an embodiment of the disclosure, there is further provided a display device, which includes any of the array substrates as stated above.

For example, the display device is a liquid crystal display device.

For example, the display device further includes a polarizer, the array substrate includes a display driving signal line, and the polarizer is attached to a face that is opposite to the display driving signal line of the array substrate.

According to at least an embodiment of the disclosure, there is further provided a manufacturing method of an array substrate, which includes forming a transmitting touch electrode pattern on a first face of a base substrate, and forming a receiving touch electrode pattern on a second face of the base substrate; the first face and the second face are opposite to each other.

For example, in an embodiment, the method further includes forming a display driving signal line over the transmitting touch electrode pattern or over the receiving touch electrode pattern.

According to at least an embodiment of the disclosure, there is further provided a manufacturing method of a display device, and the method includes steps of manufacturing an array substrate by using the manufacturing method of array substrate as stated above.

For example, in an example, the manufacturing method of the display device as stated above further includes attaching a polarizer to a face that is opposite to the display driving signal line of the array substrate after the array substrate is formed.

### BRIEF DESCRIPTION OF THE DRAWINGS

In order to illustrate the technical solution of the embodiments of the disclosure more clearly, the drawings of the embodiments will be briefly described below; it is obvious that the drawings as described below are only related to some embodiments of the disclosure, but not limitative of the disclosure.

FIG. 1 is a structurally schematic view illustrating a display panel;

FIG. 2 is a structurally schematic view illustrating an array substrate provided by an embodiment of the disclosure; and

FIG. 3 is a structurally schematic view illustrating a display device provided by an embodiment of the disclosure.

### DETAILED DESCRIPTION

In order to make objects, technical details and advantages of the embodiments of the disclosure apparent, hereinafter, the technical solutions of the embodiments of the disclosure will be described in a clearly and fully understandable way in connection with the drawings related to the embodiments of the disclosure. It is obvious that the described embodiments are just a part but not all of the embodiments of the disclosure. Based on the described embodiments of the disclosure, those ordinarily skilled in the art can obtain other embodiment(s), without any inventive work, which should be within the scope sought for protection by the disclosure.

Unless otherwise defined, the technical terminology or scientific terminology used herein should have the same meaning as commonly understood by one of ordinary skill in the art to, which this disclosure belongs. “Upper,” “lower,” “left,” “right” or the like is only used to describe a relative positional relationship, and when an absolute position of the described object is changed, the relative positional relationship might also be changed accordingly.

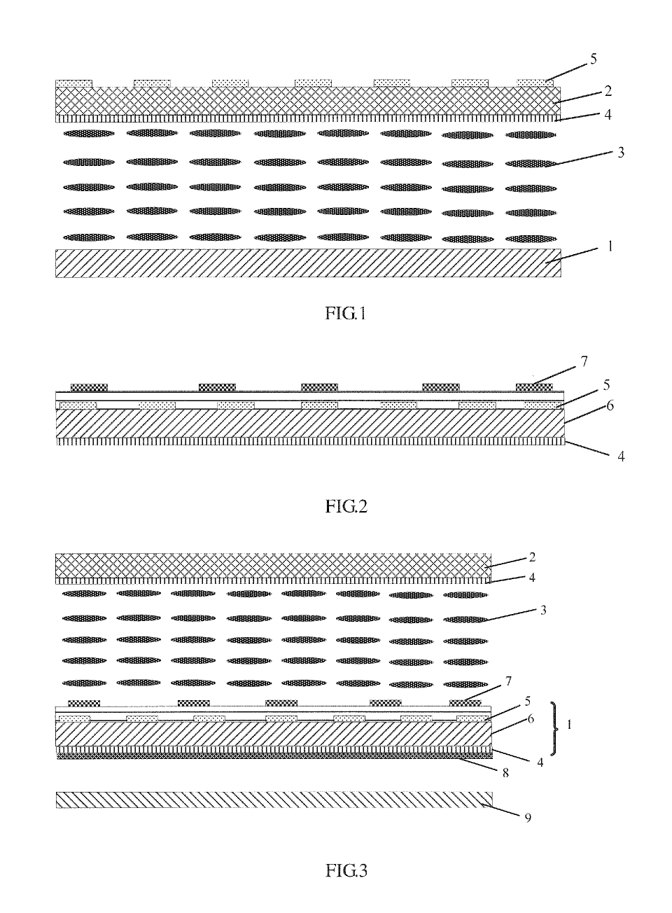

In-cell touch panels can be classified into mutual capacitive touch panels and self-capacitive touch panels according to the working principle of the panels. FIG. 1 is a structurally schematic view illustrating a display panel in an in-cell mutual capacitive touch panel. The display panel includes an array substrate 1, a color filter substrate 2 and a liquid crystal layer 3 located between the array substrate 1 and the color filter substrate 2, and moreover, it further includes a transmitting touch electrode pattern 4 and a receiving touch electrode pattern 5. The transmitting touch electrode pattern 4 is disposed on a lower surface of the color filter substrate 2, the receiving touch electrode pattern 5 is disposed on an upper surface of the color filter substrate 2, and wiring directions of the transmitting touch electrode pattern 4 and the receiving touch electrode pattern 5 are perpendicular to each other. Due to the fact that the transmitting touch electrode pattern 4 and the receiving touch electrode pattern 5 are each located in a light exiting direction of the display panel, and a shield effect against outgoing light will be invoked, this results in the fact that shadows of the transmitting touch electrode pattern 4 and the receiving touch electrode pattern 5 are included in a picture displayed by the display panel, and such shadows are very difficult to be eliminated or alleviated.

According to at least an embodiment of the present disclosure, there is provided an array substrate. As shown in FIG. 2, the array substrate includes a base substrate 6, a transmitting touch electrode pattern 4 and a receiving touch electrode pattern 5, and it further includes display driving signal lines 7. The transmitting touch electrode pattern 4 is formed on a lower surface of the base substrate 6, the receiving touch electrode pattern 5 and the display driving signal lines 7 are formed on an upper surface of the base substrate 6, and the receiving touch electrode pattern 5 is located below the display driving signal lines 7.

The transmitting touch electrode pattern 4 refers to electrodes and electrode lines that are useful for transmitting touch driving signals; and the receiving touch electrode pattern 5 refers to electrodes and electrode lines that are useful for receiving touch signals.

In embodiments of the disclosure, wiring directions of the transmitting touch electrode pattern 4 and the receiving touch electrode pattern 5 may be perpendicular to each other.

With respect to the array substrate provided by at least an embodiment of the disclosure, because the transmitting touch electrode pattern and the receiving touch electrode pattern are both located on the array substrate, they are closer to a light source as compared to the mode that they are formed on a counter substrate (color filter substrate). In this configuration, the shadows of the transmitting touch electrode pattern and the receiving touch electrode pattern can be better eliminated or alleviated. In addition, in a specific application, an upper surface of the array substrate is encapsulated inside the display panel, a polarizer may be attached to its lower surface, and a backlight source and other structure are provided on the outer side of the lower surface. Therefore, with the structure according to embodiments of the disclosure, transmitting touch electrode pattern and receiving touch electrode pattern that are both provided on the array substrate can be avoided favorably from being scratched or even broken off.

In at least an embodiment of the disclosure, the receiving touch electrode pattern 5 is disposed below the display driving signal lines 7 for example, and in this structure, interference with the display driving signal lines 7 by the receiving touch electrode pattern 5 can be reduced favorably. Thus, the normal display of the display panel is assured. Certainly, in practice, by disposing the receiving touch electrode pattern 5 below the display driving signal lines 7 or on the same layer as the display driving signal lines 7, technical effects of eliminating or alleviating shadows and avoiding scratch can be achieved as well, and corresponding technical solutions also should fall into the protection scope of the present disclosure.

It is to be noted that, the receiving touch electrode pattern 5 being located below the display driving signal lines 7 as referred to by at least an embodiment of the disclosure is not limited to the situation where the receiving touch electrode pattern 5 is located immediately below the display driving signal lines 7. In practice, as shown in FIG. 2, the receiving touch electrode pattern 5 and the display driving signal lines 7 may be separated by other layered structure.

The display driving signal lines as referred to by at least an embodiment of the disclosure may be, such as signal lines useful for display driving. For example, when the array substrate is a TFT array substrate, the display driving signal lines here may be data lines, gate lines, common electrode lines or the like for driving a TFT transistor array. When the display driving signal lines exist on multiple layers, a receiving touch electrode pattern may be located below the display driving signal lines, and for example, it is located below signal lines on the layer closest to a base substrate.

In at least an embodiment of the disclosure, the receiving touch electrode pattern 5 is provided on an upper surface of the base substrate 6 (i.e., the side on which display driving signal lines are located), and in this structure, interference with the display driving signal lines can be better avoided. But in practice, by means of providing a receiving touch electrode pattern 5 on a lower surface of the base substrate 6 and providing a transmitting touch electrode pattern 4 on an upper surface of the base substrate 6, effects of eliminating or alleviating shadows and avoiding scratch can be achieved as well, and corresponding technical solutions also fall into the protection scope of the disclosure.

In at least an embodiment of the disclosure, there is no specific restriction on the extending directions of wirings in the transmitting touch electrode pattern 4 and the receiving touch electrode pattern 5. So long as the extending directions of wirings in the transmitting touch electrode pattern 4 and the receiving touch electrode pattern 5 are perpendicular to each other, technical solutions of the disclosure can be achieved.

According to at least an embodiment of the disclosure, there is further provided a manufacturing method of an array substrate, which is usable for manufacture of the above array substrate. The method includes forming a transmitting touch electrode pattern on a first face of a base substrate, and forming a receiving touch electrode pattern on a second face of the base substrate; the first face and the second face are opposite to each other.

With respect to the array substrate that is manufactured by the manufacturing method of the array substrate provided by embodiments of the disclosure, it is possible that shadows of a transmitting touch electrode pattern and a receiving touch electrode pattern are eliminated or alleviated and the transmitting touch electrode pattern and the receiving touch electrode pattern are avoided from being scratched.

In practice, for example, it is possible that a metal layer is deposited on a respective surface (a first or second surface) of a base substrate at first, and afterwards, the metal layer is etched by using exposure and development processes, so as to form patterns of corresponding touch electrodes and touch electrode lines.

Specifically, when the manufacturing method of the array substrate provided by at least an embodiment of the disclosure is applied for manufacture of the array substrate shown in FIG. 2, the first face here may be a lower surface of the array substrate, and the second face is an upper surface of the array substrate. That is, they are located on different sides of the base substrate of the array substrate.

For example, the manufacturing method of the array substrate as stated above may further include forming display driving signal lines over the transmitting touch electrode pattern or over the receiving touch electrode pattern. This can reduce the interference with the display driving signal lines from touch electrode lines.

According to at least an embodiment of the disclosure, there is further provided a display device. As shown in FIG. 3, the display device includes an array substrate 1 and a color filter substrate 2, as well as a liquid crystal layer 3 provided between the array substrate 1 and the color filter substrate 2. The array substrate 1 here may be the array substrate as shown in FIG. 2, and includes a base substrate 6, a receiving touch electrode pattern 5 and display driving signal lines 7 that are formed on an upper surface of the base substrate 6, and a transmitting touch electrode pattern 4 formed on a lower surface of the base substrate 6. The color filter substrate 2 is an example of the counter substrate. When the array substrate 1 has color filters formed thereon, the counter substrate itself may not include color filters any more.

For example, the display device further includes a polarizer 8 and a backlight source 9. The polarizer 8 is attached to the transmitting touch electrode pattern 4 on a lower surface of the base substrate 6, and the backlight source 9 is located below the array substrate 1.

In practice, because the transmitting touch electrode pattern and the receiving touch electrode pattern are both located on the array substrate, they are closer to a light source as compared to the mode that they are formed on a color filter substrate. With this structure, the shadows of the transmitting touch electrode pattern and the receiving touch electrode pattern can be eliminated or alleviated. In addition, in a specific application, an upper surface of the array substrate is encapsulated inside the display panel, a polarizer may be attached to its lower surface, and a backlight source and other structure may be provided on an outer side of the lower surface. Consequently, transmitting touch electrode pattern and receiving touch electrode pattern that are provided on the array substrate can be favorably avoided from being scratched.

Embodiments of the display device may be an electronic paper, a cell phone, a tablet computer, a television, a display, a notebook computer, a digital photo frame, a navigator and any other product or component having a display function.

According to at least an embodiment of the disclosure, there is further provided a manufacturing method of a display device. The method includes steps of manufacturing an array substrate by using the manufacturing method of the array substrate as stated in the above embodiments, and it further includes that, after formation of the array substrate, a polarizer is attached to a touch electrode pattern that is formed on an opposite face of display driving signal lines of the array substrate.

Descriptions made above are merely exemplary embodiments of the disclosure, but are not used to limit the protection scope of the disclosure. The protection scope of the disclosure is determined by attached claims.

This application claims the benefit of priority from Chinese patent application No. 201510100099.7, filed on Mar. 6, 2015, the disclosure of which is incorporated herein in its entirety by reference as a part of the present application.

What is claimed is:

1. An array substrate, comprising:
a base substrate, and
a transmitting touch electrode pattern and a receiving touch electrode pattern;
wherein the transmitting touch electrode pattern is formed on a first face of the base substrate, the receiving touch electrode pattern is formed on a second face of the base substrate, and the first face and the second face are opposite to each other.

2. The array substrate claimed as claim 1, further comprising a display driving signal line,
wherein the transmitting touch electrode pattern or the receiving touch electrode pattern is located on the same face as the display driving signal line of the array substrate, and is formed below the display driving signal line.

3. The array substrate claimed as claim 1, wherein wirings of the transmitting touch electrode pattern and wirings of the receiving touch electrode pattern are perpendicular to each other.

4. The array substrate claimed as claim 2, wherein wirings of the transmitting touch electrode pattern and wirings of the receiving touch electrode pattern are perpendicular to each other.

5. A display device, comprising the array substrate claimed as claim I.

6. The display device claimed as claim 5, wherein the display device is a liquid crystal display device.

7. The display device claimed as claim 6, further comprising a polarizer, wherein the array substrate includes a display driving signal line, and the polarizer is attached to a face that is opposite to the display driving signal line of the array substrate.
